(19) United States
(12) Patent Application Publication
(10) Pub. No.: US 2025/0061435 A1
(43) Pub. Date: Feb. 20, 2025

(54) SYSTEMS AND METHODS FOR REAL-TIME PULL RESOURCE TRANSFERS

(71) Applicant: WELLS FARGO BANK, N.A., San Francisco, CA (US)

(72) Inventor: Alan W. Hecht, Richmond, CA (US)

(73) Assignee: WELLS FARGO BANK, N.A., San Francisco, CA (US)

(21) Appl. No.: 18/807,258

(22) Filed: Aug. 16, 2024

Related U.S. Application Data
(60) Provisional application No. 63/533,578, filed on Aug. 18, 2023.

(51) Int. Cl. G06Q 20/10; G06Q 20/40

(52) U.S. Cl. CPC G06Q 20/108; G06Q 20/401

(57) ABSTRACT

A method includes: receiving, by a computing system, a pre-authorization request from a first client application associated with a first account held at a first provider institution, the pre-authorization request requesting that the first account be bound to a second account held at a second provider institution, wherein binding the first account to the second account pre-authorizes a first user of the first account to perform real-time or near real-time pull transfers of resources from the second account into the first account using a transfer service; transmitting, by the computing system, the pre-authorization request to a second client application associated with the second account; receiving, by the computing system, an approval of the pre-authorization request from the second client application associated with the second account; and binding, by the computing system, the first account with the second account based on the approval of the pre-authorization request.

### CROSS-REFERENCE TO RELATED APPLICATION

This application claims the benefit of and priority to U.S. Patent Application No. 63/533,578, filed Aug. 18, 2023, which is incorporated herein by reference in its entirety.

### TECHNICAL FIELD

The present disclosure relates to systems and methods for real-time pull resource transfers.

### BACKGROUND

Requests for payment (RFPs) have been used to enable a wide variety of transfers. Additionally, various payment service providers have enabled real-time or near real-time payments to be made between various financial accounts utilizing RFPs. For example, a traditional real-time payment may be initiated by a user sending an RFP from a first account to a user associated with second account (e.g., via a banking or fund transfer service application). The user associated with the second account may then approve the requested transaction, at which time the requested amount of funds are pushed from the second account to the first account.

### SUMMARY

One embodiment relates to a method. The method includes receiving, by a computing system, a pre-authorization request from a first client application associated with a first account held at a first provider institution, the pre-authorization request requesting that the first account be bound to a second account held at a second provider institution, wherein binding the first account to the second account pre-authorizes a first user of the first account to perform real-time or near real-time pull transfers of resources from the second account into the first account using a transfer service. The method further includes transmitting, by the computing system, the pre-authorization request to a second client application associated with the second account. The method further includes receiving, by the computing system, an approval of the pre-authorization request from the second client application associated with the second account. The method further includes binding, by the computing system, the first account with the second account based on the approval of the pre-authorization request.

Another embodiment relates to one or more non-transitory computer-readable media having instructions thereon that, when executed by at least one processing circuit of a computing system, cause the at least one processing circuit to perform operations. The operations include receiving a registration request to register a first account held at a first provider institution with a transfer service from a first client application associated with the first account, the registration request including a user characteristic of a user associated with the first account. The operations further include determining that the user characteristic matches an existing universal transfer identifier registered with the transfer service. The operations further include identifying a second account held at a second provider institution as being associated with the existing universal transfer identifier. The operations further include, in response to identifying the second account as being associated with the existing universal transfer identifier, providing an indication of the second account to the first client application. The operations further include binding the first account to the second account based on a pre-authorization request from the first client application being approved by a second client application associated with the second account, wherein binding the first account to the second account pre-authorizes a first user of the first account to perform real-time or near real-time pull transfers of resources from the second account into the first account using the transfer service.

Yet another embodiment relates to a transfer service computing system. The transfer service computing system includes one or more processing circuits including one or more processors and one or more memories, the one or more memories having instructions stored thereon that, when executed by the one or more processors, cause the one or more processing circuits to receive a pre-authorization request from a first client application associated with a first account held by a user at a first provider institution, the pre-authorization request requesting that the first account be bound to a second account held by the user at a second provider institution, wherein binding the first account to the second account pre-authorizes the user to perform real-time or near real-time pull transfers of resources from the second account into the first account using a transfer service. The instructions further cause the one or more processing circuits to transmit the pre-authorization request to a second client application associated with the second account. The instructions further cause the one or more processing circuits to receive an approval of the pre-authorization request from the second client application associated with the second account. The instructions further cause the one or more processing circuits to bind the first account with the second account based on the approval of the pre-authorization request.

Still another embodiment relates to a provider computing system associated with a first provider institution. The provider computing system includes one or more processing circuits including one or more processors and one or more memories, the one or more memories having instructions stored thereon that, when executed by the one or more processors, cause the one or more processing circuits to receive a pre-authorization request from a first client application associated with a first account held by a user at the first provider institution. The pre-authorization request may request that the first account be bound to a second account held by the user at a second provider institution, whereby binding the first account to the second account pre-authorizes the user to perform real-time or near real-time pull transfers of resources from the second account into the first account using a transfer service. The instructions, when executed by the one or more processors, may further cause the one or more processing circuits to transmit the pre-authorization request to a second client application associated with the second account. The instructions, when executed by the one or more processors, may further cause the one or more processing circuits to receive an approval of the pre-authorization request from the second client application associated with the second account. The instructions, when executed by the one or more processors, may further cause the one or more processing circuits to receive a notification that the first account has been bound with the second account based on the approval of the pre-authorization request.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for enabling real-time or near real-time pull resource transfers, according to an example embodiment.

FIG. 2 is flow diagram of a method for pre-authorizing and completing a real-time or near real-time pull resource transfer, according to an example embodiment.

FIG. 3 is a graphical user interface providing a transfer page, according to an example embodiment.

FIG. 4 is a graphical user interface providing a received request alert or notification, according to an example embodiment.

### DETAILED DESCRIPTION

Referring generally to the Figures, systems and methods for enabling real-time resource transfers, and particularly pull transfers, are disclosed according to various embodiments herein. In some instances, the systems, computer-readable media, and methods described herein allow for a user associated with a first account to request pre-authorization for future pull transfers from a second account. A transfer service (also referred to as a transfer computing system) then routes that request to the second account and a user associated with the second account can then approve the pre-authorization request. Upon approval of the pre-authorization request, the transfer service is configured to bind the first account to the second account to allow for the user associated with the first account to automatically perform future resource pull transfers of resources from the second account to the first account without requiring a subsequent approval or authorization of those resource pull transfers due to the user of the first account being pre-authorized.

Technically and beneficially, the systems, computer-readable media, and methods described herein provide various technical improvements over past real-time or near real-time transfer systems. For example, traditional real-time or near real-time transfer systems have not allowed for pull transfers and have traditionally required a responsive authorization action by the sending user (i.e., the user associated with the account from which funds or resources are being transferred). That is, in a traditional real-time or near real-time transfer system, a request for payment is sent from a first user or user account to a second user or user account requesting some amount of funds or other resources. Upon receiving the request for funds or other resources, if the second user or user account approves (e.g., authorizes the transfer), the funds or resources are then pushed from the second user account to the first user account. As such, due to the funds or resources being pushed from the second user account to the first user account responsive to the post-request authorization, the receiving user (e.g., the first user from the preceding example) has traditionally faced potential delays from the sending user (e.g., the second user from the preceding example) authorizing their requests. Similarly, in the case that the user is requesting funds or resources be transferred between their own accounts that are held at different entities (e.g., a me-to-me transfer between an account at Bank A and an account at Bank B), the customer has been required to log into a first account, request a fund transfer from a second account, log out of the first account, log into the second account, and then approve the requested fund or resource transfer from the first account. At a minimum, this process requires four steps, multiple clicks, multiple credential submissions, and in turn is a circuitous route for enabling a me-to-me transfer. As such, customers have traditionally had to perform a cumbersome set of steps to move their own funds and resources between accounts held at different provider institutions.

The aforementioned delays and cumbersome steps create a variety of technical problems that increase bandwidth and power consumption of the traditional real-time or near real-time transfer systems. For example, by requiring that the party approving a given payment provide authorization for each individual transfer of resources, traditional real-time or near real-time transfer systems are required to repetitively generate and transmit associated user interfaces to various devices to be presented to the approving party to authorize each individual transfer of resources, thereby increasing the computational burden and the bandwidth consumption requirements of the traditional real-time or near real-time transfer systems for enabling the real-time or near real-time transfers.

The systems, computer-readable media, and methods described herein solve the aforementioned issues and technical problems by allowing for users to pre-authorize real-time or near real-time pull resource transfers. According to one embodiment, this pre-authorization is performed once (although the pre-authorization may be performed periodically if the user does not wish to endlessly grant pre-authorization in a given scenario) and binds a receiving account to a sending account to allow for the receiving account to perform real-time or near real-time pull transfers from the sending account to the receiving account using the transfer service without requiring additional authorization. As such, the systems, computer-readable media, and methods described herein reduce and/or may eliminate the potential for delay when requesting a fund or resource transfer from another user who has granted pre-authorization and also reduce and/or may eliminate a plurality of traditionally required steps, such as clicks to access various accounts, for a user transferring funds between their own accounts via real-time or near real-time transfers.

Furthermore, by allowing for the users to pre-authorize real-time or near real-time pull transfers, the systems, computer-readable media, and methods described herein eliminate or greatly reduce the need to repetitively generate and transmit user interfaces to various devices associated with authorizing resource transfer requests, and thereby solve the technical problems discussed above and effectively reduce the computational burden and the bandwidth consumption requirements needed to enable real-time or near-real time pull transfers as compared to traditional real-time or near real-time transfer systems.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

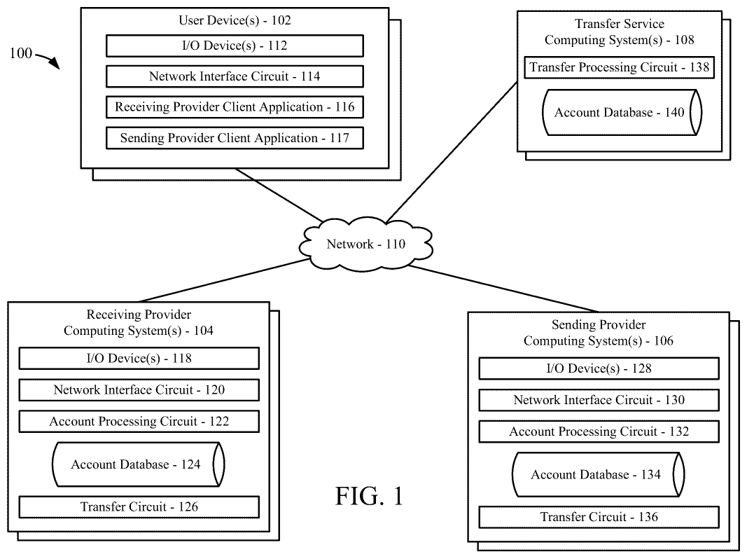

FIG. 1 is a diagram of a computing environment 100 for enabling real-time pull resource transfers, according to an example embodiment. As described herein, a resource may be something of value and, particularly in the embodiments described herein, may be money or currency. As shown, the computing environment 100 includes one or more user devices 102, one or more receiving provider computing systems 104, one or more sending provider computing systems 106, and a transfer service computing system 108. The user device(s) 102, the receiving provider computing system(s) 104, the sending provider computing system(s) 106, and the transfer service computing system 108 are in communication with each other and are connected by a network 110.

For clarity, the following description will refer to a user device 102, a receiving provider computing system 104, a sending provider computing system 106, and a transfer service computing system 108. However, it will be understood that, in some instances, the computing environment 100 may include multiple user devices similar to the user device 102, multiple receiving provider computing systems similar to the receiving provider computing system 104, multiple sending provider computing systems similar to the sending provider computing system 106, and/or multiple transfer service computing systems similar to the transfer service computing system 108.

The user device 102 is owned, operated, controlled, managed, and/or otherwise associated with a user. In some embodiments, the user device 102 may be or may comprise, for example, a desktop or laptop computer, a smartphone, a tablet computer, a wearable device (e.g., a smartwatch), a personal digital assistant, and/or any other suitable computing device.

In some embodiments, the user device 102 includes one or more I/O devices 112, a network interface circuit 114, and one or more user client applications (e.g., a receiving provider client application 116 and a sending provider client application 117). While the term “I/O” is used, it should be understood that the I/O devices 112 may be input-only devices, output-only devices, and/or a combination of input and output devices. In some instances, the I/O devices 112 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.). In some instances, the I/O devices 112 further comprise one or more user interfaces (devices or components that interface with the user), which may include one or more biometric sensors (such as a fingerprint reader, a heart monitor that detects cardiovascular signals, face scanner, an iris scanner, etc.).

The network interface circuit 114 includes, for example, program logic and various devices (e.g., transceivers, etc.) that connect the user device 102 to the network 110. The network interface circuit 114 facilitates secure communications between the user device 102 and each of the receiving provider computing system 104, the sending provider computing system 106, and the transfer service computing system 108. The network interface circuit 114 also facilitates communication with other entities, such as other banks, settlement systems, and so on.

The user device 102 stores in computer memory, and executes (“runs”) using one or more processors, various user client applications configured to enable various functionalities. In some instances, the user client applications comprise various Internet browser applications presenting websites and/or applications provided other entities.

The user client applications may include a receiving provider client application 116. In some instances, the receiving provider client application 116 may be a financial institution banking application provided by and at least partly supported by the receiving provider computing system 104. In some instances, the receiving provider client application 116 is coupled to the receiving provider computing system 104 may enable account management regarding one or more accounts held at the receiving provider institution associated with the receiving provider computing system 104 (e.g., funds transfers, bill payment, etc.). In some instances, the receiving provider institution application provided by the receiving provider computing system 104 incorporates various functionality provided by or otherwise enabled by the transfer service computing system 108 (e.g., initiating and/or approving transfers) using one or more application programming interfaces (APIs) and/or software development kits (SDKs) provided by the transfer service computing system 108.

The user client applications may also include a sending provider client application 117. In some instances, the sending provider client application 117 is a financial institution banking application provided by and at least partly supported by the sending provider computing system 106. In some instances, the sending provider client application 117 is coupled to the sending provider computing system 106 may similarly enable account management regarding one or more accounts held at the sending provider institution associated with the sending provider computing system 106 (e.g., funds transfers, bill payment, etc.). In some instances, the sending provider institution application provided by the sending provider computing system 106 similarly incorporates various functionality provided by or otherwise enabled by the transfer service computing system 108 (e.g., initiating and/or approving transfers) using one or more application programming interfaces (APIs) and/or software development kits (SDKs) provided by the transfer service computing system 108.

In some instances, the user client applications further comprise a transfer service client application provided by and at least partly supported by the transfer service computing system 108. In some instances, the transfer service application may enable the user to initiate and/or approve various transactions enabled by a transfer service associated with the transfer service computing system 108, as described below. In some instances, the transfer service client application is coupled to the transfer service computing system 108 may similarly enable account management and/or various account functionalities regarding one or more accounts held at the transfer service entity (e.g., within the account database 140) associated with the transfer service computing system 108 (e.g., funds transfers, transfer preferences, etc.). In some instances, the transfer service client application provided by the transfer service computing system 108 similarly incorporates various functionality provided by or otherwise enabled by the receiving provider computing system 104 and/or the sending provider computing system 106 (e.g., initiating fund or other resource transfers from a first provider financial account to a second provider financial account) using one or more application programming interfaces (APIs) and/or software development kits (SDKs) provided by the receiving provider computing system 104 and/or the sending provider computing system 106.

Accordingly, the receiving provider client application 116, the sending provider client application 117, and the transfer service client application are structured to provide the user with access to various services offered by the receiving provider, the sending provider, and the transfer service, respectively. In some embodiments, the receiving provider client application 116, the sending provider client application 117, and/or the transfer service client application are hard coded onto the memory of the user device 102. In some embodiments, the receiving provider client application 116, the sending provider client application 117, and/or the transfer service client application are web-based interface applications, where the user has to log onto or access the web-based interface before usage, and these applications are supported by a separate computing system comprising one or more servers, processors, network interface circuits, or the like (e.g., the receiving provider computing system 104, the sending provider computing system 106, the transfer service computing system 108), that transmit the applications for use to the user device 102.

The receiving provider computing system 104 is operated by a provider institution (e.g., a provider of goods and/or services and particularly financial goods and/or services, such as a bank or other financial institution) that maintains one or more accounts held by various customers (e.g., the user associated with the user device 102), such as demand deposit accounts, credit card accounts, receivables accounts, and so on. In some instances, the receiving provider computing system 104, for example, may comprise one or more servers, each with one or more processing circuits having one or more processors configured to execute instructions stored in one or more memory devices to send and receive data stored in the one or more memory devices and perform other operations to implement the functionality and methods described herein. In some instances, the receiving provider computing system 104 may comprise and/or have various other devices communicably coupled thereto, such as, for example, desktop or laptop computers, smartphones, tablet computers, wearable devise (e.g., smartwatches), and/or other suitable devices.

In some embodiments, the receiving provider computing system 104 includes one or more I/O devices 118, a network interface circuit 120, an account processing circuit 122, an account database 124, and a transfer circuit 126. While the term “I/O/is used, it should be understood that the I/O devices 118 may similarly be input-only devices, output-only devices, and/or a combination of input and output devices. In some instances, the I/O devices 118 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.).

In some instances, the network interface circuit 120 includes, for example, program logic that connects the receiving provider computing system 104 to the network 110. For example, in some instances, the program logic interfaces with one or more transceivers (e.g., Bluetooth, Wi-Fi, or any other suitable communication transceivers) to enable connection to the network 110. The network interface circuit 120 facilitates secure communications between the receiving provider computing system 104 and each of the user device 102, the sending provider computing system 106, and the transfer service computing system 108. The network interface circuit 120 also facilitates communication with other entities, such as other banks, settlement systems, and so on. The network interface circuit 120 further includes user interface program logic configured to generate and present web pages to users accessing the receiving provider computing system 104 over the network 110.

The account processing circuit 122 performs account processing to process transactions in connection with the account(s) stored within an account database 124, such as account credits and debits to checking and savings accounts, credits and debits to home mortgage and home equity accounts, credits and debits to student loan accounts, and so on. Thus, when funds are transferred into or out of an account, the account processing circuit 122 is configured to track the transaction and modify an entry/ledger in the account database 124 to reflect the debit or credit.

The account database 124 stores account information (e.g., transaction information, information about the account holder, information pertaining to the type and corresponding capabilities of a given account, and so on) for accounts that are maintained by the receiving provider institution on behalf of its customers. The account database 124 is configured to be used by the account processing circuit 122 to identify various accounts associated with various transfers (e.g., funds transfers).

The sending provider computing system 106 is operated by a sending provider institution (e.g., a provider of goods and/or services and particularly financial goods and/or services, such as a bank or other financial institution) that maintains accounts held by various customers (e.g., the user associated with the user device 102), such as demand deposit accounts, mortgage account, credit card accounts, and so on. In some embodiments, the sending provider computing system 106 and the receiving provider computing system 104 are owned by, operated by, managed by, and/or otherwise controlled by different provider institutions (e.g., Bank A versus Bank B).

In some instances, the sending provider computing system 106 comprises one or more servers, each with one or more processing circuits having one or more processors configured to execute instructions stored in one or more memory devices, send and receive data stored in the one or more memory devices, and perform other operations to implement the operations described herein associated with logic or processes shown in the figures. In some instances, the sending provider computing system 106 may comprise and/or have various other devices communicably coupled thereto, such as, for example, desktop or laptop computers, smartphones, tablet computers, wearable devise (e.g., smartwatches), and/or other suitable devices.

In some embodiments, the sending provider computing system 106 includes one or more I/O devices 128, a network interface circuit 130, an account processing circuit 132, an account database 134, and a transfer circuit 136. In some instances, the I/O devices 128, the network interface circuit 130, the account processing circuit 132, the account database 134, and the transfer circuit 136 are substantially similar to the I/O devices 118, the network interface circuit 120, the account processing circuit 122, the account database 124, and the transfer circuit 126 of the receiving provider computing system 104. Accordingly, the description of the various components of the receiving provider computing system 104 provided above is similarly applicable to the various components of the sending provider computing system 106.

The transfer service computing system 108 is controlled by, managed by, owned by, and/or otherwise associated with a transfer service entity (e.g., Zelle®, RTP®, FedNow®) that is configured to enable real-time or nearly real-time transfers. As described herein and in one embodiment, the “transfer” is a payment or fund/resource transfer. However, the present disclosure is also applicable with other types of transfers, such as the secure transfer of information (e.g., documents). The payment or fund transfer may include electronic or digital fund transfers.

In some instances, the transfer service entity may be a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third-party vendor. As still another example, the transfer service entity may be provided by one of the provider institutions, such that the provider institution performs both the operations described herein as being performed by the receiving provider computing systems 104 or the sending provider computing system 106 and the operations described herein as being performed by the transfer service computing system 108.

The transfer service computing system 108 is configured, in various embodiments, to provide (e.g., through its own client application or through integration with a client application of another entity, such as the receiving provider client application 116 and/or the sending provider client application 117) at least some of the functionality depicted in the figures and described herein (e.g., enabling transfers between sending accounts held by the sending provider and receiving accounts held by the receiving provider). For example, in some instances, the transfer service entity provides or hosts a web portal provided for an online community of individuals where such individuals obtain usernames/login IDs or otherwise become registered members to enable real-time or nearly real-time transfers.

In some instances, as discussed above, at least some of the functionality performed by the transfer service computing system 108 is integrated within various banking applications (e.g., the receiving provider client application 116 and/or the sending provider client application 117) provided by the receiving provider computing system 104 or the sending provider computing system 106 to the user device 102. For example, in some instances, the transfer service computing system 108 includes one or more APIs that securely communicate with the receiving provider computing system 104 and/or the sending provider computing system 106 and allow for various functionality performed by the transfer service computing system 108 to be embedded within the receiving provider client application 116 provided by the receiving provider computing system 104 and/or the sending provider client application 117 provided by the sending provider computing system 106 to the user device 102.

In some embodiments, transfer service computing system 108 may, for example, comprise one or more servers, each with one or more processing circuits including one or more processors configured to execute instructions stored in one or more memory devices, send and receive data stored in the one or more memory devices, and perform other operations to implement the methods and functionalities described herein. Although not specifically shown, it will be appreciated that the transfer service computing system 108 may include a network interface circuit, various databases, an account processing circuit, and other circuits in the same or similar manner to the other components of computing environment 100. In some instances, the network interface circuit may include user interface program logic configured to generate and present application pages, web pages, and/or various other data to users accessing the transfer service computing system 108 over the network 110.

The transfer processing circuit 138 is configured to enable real-time or near real-time transfers between registered users of the transfer service. In some instances, various providers (e.g., the receiving provider associated with the receiving provider computing system 104 and/or the sending provider associated with the sending provider computing system 106) may opt into the transfer service to allow their customers (e.g., the user associated with the user device 102) to register their accounts for the transfer service. In some instances, opting into the transfer service may include the corresponding providers accepting various terms and conditions for allowing the transfer service to enable transfers between accounts held by different providers.

Once the providers have opted into the transfer service, the providers' customers are able to register for and utilize the transfer service provided by the transfer service computing system 108. For example, in some instances, during a registration process, the transfer service computing system 108 is configured to receive one or more desired transfer service identifiers (e.g., a Zelle® identifier), such as a phone number, an e-mail address, an alphanumeric tag, another token, etc., to be associated with a customer (e.g., the user associated with the user device 102) registering for the transfer service. During the registration process, the transfer service computing system 108 is further configured to receive various account information (e.g., a bank routing number, a bank account number) and identifying information (e.g., a name, a phone number, an e-mail address, a physical address) associated with the customer to be linked to the corresponding received desired transfer service identifier(s) for registering the customer with the transfer service.

Accordingly, the transfer service computing system 108 is configured to receive a registration request from the user device 102 to register a particular account of the user (e.g., an account held by the receiving or sending provider stored within the account database 124 or the account database 134) for the transfer service. Upon receiving the registration request, the transfer service computing system 108 is configured to store the transfer service identifier, the account information, and the identifying information for the user within an account database 140 and to link the transfer service identifier to the account information and the identifying information within the account database 140 to register the user with the transfer service.

Once the transfer service identifier, the account information, and the identifying information for the user have been stored and linked within the account database 140, the transfer processing circuit 138 is configured to, upon receipt of a transfer request (e.g., received from the user device 102, the receiving provider computing system 104, or the sending provider computing system 106), query the account database 140 to retrieve the corresponding account information and identifying information associated with recipient and sender transfer service identifiers included in the requested transfer. Once the corresponding account information is successfully retrieved by the transfer processing circuit 138, the transfer processing circuit 138 is configured to initiate a transfer (e.g., of funds) from an account associated with the sender to an account associated with the recipient.

In some instances, users are allowed to register for the transfer service using accounts held at multiple different provider institutions. In these instances, the users register for the transfer service with each provider institution using a different transfer service identifier (e.g., a Zelle® identifier) that is then linked or otherwise associated with that particular account and provider institution within the account database 140. Accordingly, in some instances, a single user may be registered for multiple transfer service identifiers associated with multiple different provider institutions.

In some instances, to allow for the transfer service computing system 108 to identify the various transfer service identifiers associated with each user across multiple accounts held at multiple different provider institutions, the transfer service computing system 108 assigns a universal identifier to each user registered for the transfer service. For example, in some instances, in addition to the registration process discussed above, the transfer service computing system 108 may separately utilize the received identifying information associated with the user to determine whether the user has already been associated with a universal identifier and, if not, generate a new universal identifier for the user. In some instances, the universal identifier is any of a numeric, an alphabetic, alphanumeric, or other string of characters of a set or variable length. For example, in some instances, the universal identifier may be generated for a user using a random number generator or another random string generation process. In some instances, the universal identifier may be linked to the user's name, address, date of birth, and social security number (e.g., within the account database 140).

In some instances, the account database 140 includes one or more multi-dimensional tables that are configured to retrievably store cross-correlated information pertaining to the various accounts, users, transfer identifiers, and universal identifiers associated with the transfer service. For example, the multi-dimensional tables may store correlations between the various transfer identifiers for each user, various identifying information associated with each user (e.g., the user's name, address, date of birth, social security number, etc.), and their corresponding universal identifier that may be accessed via a query by the transfer service computing system 108.

Accordingly, if the user registers for a new transfer service identifier with a new provider institution, if the user's name, address, date of birth, and social security number (which are exemplary items as certain instances may use more user attributes, different user attributes, or less user attributes) match those associated with or otherwise linked to an existing universal identifier (e.g., stored within the account database 140), the transfer service computing system 108 is able to identify that it is the same user registering for the new transfer service identifier. In some instances, the transfer service computing system 108 further stores a list of each transfer service identifier associated with or otherwise linked to each user and associates or otherwise links that list with the user's universal identifier. As such, in some instances, the transfer service computing system 108 is configured to transmit a list of the user's various transfer service identifiers and associated account information to the user (e.g., to the user device 102). Further, because the multiple accounts are linked or cross-correlated with the universal identifier within the account database, the transfer service computing system 108 is beneficially configured to identifier the various transfer service identifiers associated with the user without having to communicate with multiple providers, thereby reducing the number of communications sent by the transfer service computing system 108, and thus the required communication network bandwidth requirements, as compared to a system that communicates with each individual provider to determine whether the user has a corresponding registered account.

In some instances, the transfer service computing system 108 is configured to allow for users to bind accounts to allow for real-time or near real-time pull transfers. That is, in some instances, as will be described below, users may utilize the transaction service to send a pre-authorization request from a first account to a second account that requests authorization to make future real-time pull transfers from the second account to the first account. Once the user associated with the second account (e.g., the same user or a different user from the user associated with the first account) approves the pre-authorization request, the transfer service binds the first account with the second account within the account database 140 to allow for the first account to pull resources (e.g., funds) from the second account without needing additional authorization. In some instances, the pre-authorization request may include various terms and conditions for the authorization, such that only transfer requests meeting various criteria are approved and performed without additional authorization, as will be described below.

As discussed above, the account database 140 stores transfer service identifiers, corresponding account information, and corresponding identifying information for various transfer service accounts that are maintained by the transfer service on behalf of its users. The account database 140 is configured to be used by the transfer processing circuit 138 to enable the real-time or near real-time transfers discussed above.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

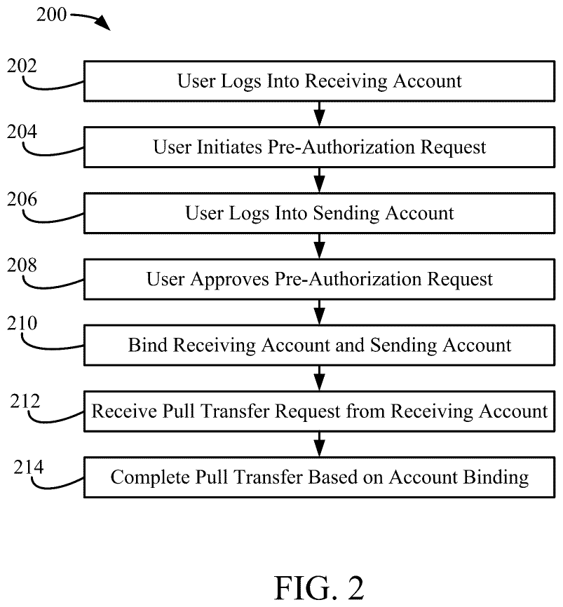

Referring to FIG. 2, a flow diagram of a method 200 for pre-authorizing and completing a real-time or near real-time pull of resources from a sending account (e.g., held by the sending provider within the account database 134) to a receiving account (e.g., held by the receiving provider within the account database 124) is shown, according to an example embodiment. As used herein, the “receiving account” is meant to refer to the account that is pre-authorized to receive pulled funds or other resources from the sending account. Similarly, the “sending account” is configured to send funds or other resources to the receiving account when they are pulled. Various operations of the method 200 may be conducted by the computing environment 100 (e.g., the user device 102, the receiving provider computing system 104, the sending provider computing system 106, and the transfer service computing system 108).

As shown, the method 200 begins with a user logging into a receiving account, at step 202. For example, in some instances, the user may log into the receiving account via a banking application (e.g., the receiving provider client application 116) using one or more login credentials (e.g., passwords, passcodes, biometrics, etc.) on the user device 102. Accordingly, the user may be presented with a variety of account-related options within the context of the banking application. In some instances, these options include an option to initiate a real-time or near real-time request for payment (RFP) using the transfer service provided by the transfer service computing system 108 described herein. For example, in some instances, the user registers for the transfer service within the banking application and is subsequently allowed to initiate transactions to other registered users of the transfer service by selecting the corresponding option.

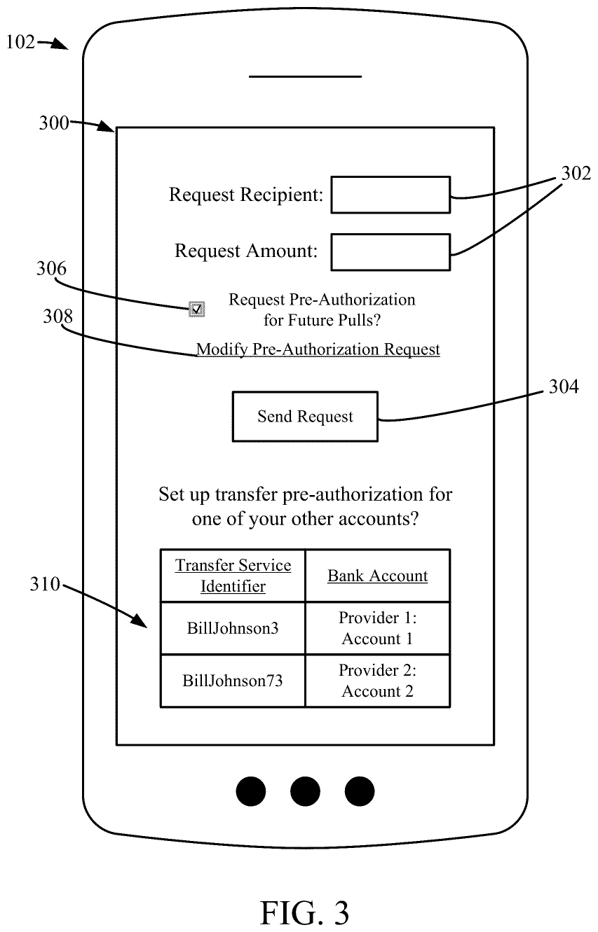

In some instances, upon selecting the option to initiate a real-time or near real-time RFP using the transfer service, the user is navigated to a transfer page within the banking application (e.g., the receiving provider client application 116) or transfer service application on the user device 102. For example, referring to FIG. 3, a graphical user interface 300 providing a transfer page is shown, according to an example embodiment. As shown, the graphical user interface 300 includes entry fields 302 configured to allow the user to enter a request recipient (e.g., a transfer service identifier, a name, a phone number, an e-mail) and request amount (e.g., an amount of funds or resources requested). The user may then press a send request button 304 to initiate a normal real-time or near real-time RFP requesting funds be transferred from a sending account associated with the request recipient to a receiving account associated with the user.

However, the graphical user interface 300 further includes a checkbox 306 that is selectable to allow the user to request pre-authorization for further pull transfers from the sending account associated with the request recipient and a link 308 that allows the user to modify various terms associated with the pre-authorization request. In some instances, if the request recipient is a user other than the user sending the request (i.e., the pre-authorization is being requested to for pull transfers between accounts associated with different users), the user may wish to set various proposed terms and conditions associated with the pre-authorization request to be sent along with the pre-authorization request.

For example, in some instances, the pre-authorization request may be configured to pre-authorize pulls transfers associated with a bill or another recurring payment (e.g., a loan payment). Accordingly, in these instances, the user sending the pre-authorization request may be a biller (e.g., a service provider, a merchant, a financing service, etc.), and the proposed terms and conditions may include various limits and timeframes within which the entity requesting pre-authorization is allowed to pull funds or resources from the request recipient's account (e.g., the sending account). These limits and timeframes may, for example, specify that, if accepted by the request recipient, the entity requesting pre-authorization would only be allowed to pull funds or resources of a certain exact approved value (e.g., a monthly cable bill amount), up to an approved transfer limit (e.g., transfers totaling up to $1,000) and/or with a given time period (e.g., the first Monday of every month). In some instances, the proposed terms and conditions may include a proposed duration of the pre-authorization. For example, in some instances, a user may not wish to provide endless pre-authorization for pull transfers to other entities (e.g., a service provider, a merchant, a financing service). Accordingly, the proposed terms and conditions can specify how long the entity has pre-authorization to pull from the user's account (e.g., the sending account). For example, in some instances, the proposed duration may be for a week, a month, a quarter year, a year, or any other suitable timeframe.

In some instances, the user is provided with a list of other user accounts 310 associated with the user and registered with the transfer service. In some instances, the list of other user accounts 310 may include the transfer service identifiers and corresponding account identifiers (e.g., account numbers, routing numbers, indications of the provider institutions at which the accounts are held) associated with those transfer service identifiers. For example, in some instances, the transfer service computing system 108 (e.g., the transfer processing circuit 138) is configured to identify the universal identifier associated with the user based on the transfer service identifier associated with the receiving account that the user is logged into. The transfer service computing system 108 (e.g., the transfer processing circuit 138) is then configured to identify the user's other transfer service identifiers and corresponding financial accounts based on the universal identifier, as described above. That is, as discussed above, the account database 140 may include one or more multi-dimensional tables that are configured to store cross-correlated information pertaining to various accounts, users, transfer identifiers (e.g., Zelle® tags), and universal identifiers associated with users. Accordingly, upon the user logging into the receiving account, the transfer service computing system 108 may query the account database 140 to determine whether the user has any additional transfer service identifiers registered with the transfer service by determining whether the universal identifier associated with the user has been cross correlated with any other transfer service identifiers within the account database 140. In some instances, the list of other user accounts 310 is selectable on the graphical user interface and is automatically filled into the entry field 302 for the request recipient upon selection.

It should be appreciated that, while the graphical user interface 300 includes the entry field 302 for the request amount, in some instances, when requesting pre-authorization, the request sent to the request recipient may not include a request amount. Accordingly, in these instances, the request for pre-authorization is transmitted along the same RFP rails as the normal RFP requests enabled by the transfer service, but do not include a requested amount. However, in some instances, the request for pre-authorization can be accompanied within the same request transmission by a request for a particular amount of funds or other resources.

Accordingly, with reference again to FIG. 2, the user sending the request then initiates the pre-authorization request to pre-authorize real-time or near real-time pull transfers from a sending account (e.g., associated with the request recipient) into the receiving account (e.g., associated with the user sending the request), at step 204.

At step 206, a user then logs into the sending account. For example, in some instances, the user may log into the sending account via a banking application (e.g., the sending provider client application 117) using one or more login credentials (e.g., passwords, passcodes, biometrics, etc.) on the user device 102. It should be appreciated that, in some instances, the user logging into the sending account is the same user that logged into the receiving account (e.g., in the case of a me-to-me transfer between different accounts of the same user). For example, a user may wish to pre-authorize pull transfers from their direct deposit account held by a first provider into a brokerage account held by a second provider. In some other instances, the user logging into the sending account is a different user than the user that logged into the receiving account.

In any case, upon logging into the sending account, the user may receive an alert or a notification (e.g., a pop-up window or other user interface) indicating that they have received a request from the user associated with the receiving account. In some instances, the alert or notification may be presented to the user as a disruption to the normal login process (e.g., a splash page that the user presented with prior to the user being to access other functionality of the banking application). This disruption to the normal login process provides additional security by forcing the user to review the pertinent details associated with the requested transfer and pre-authorization request before approving or denying the request, thereby reducing the likelihood of inadvertent transfers.

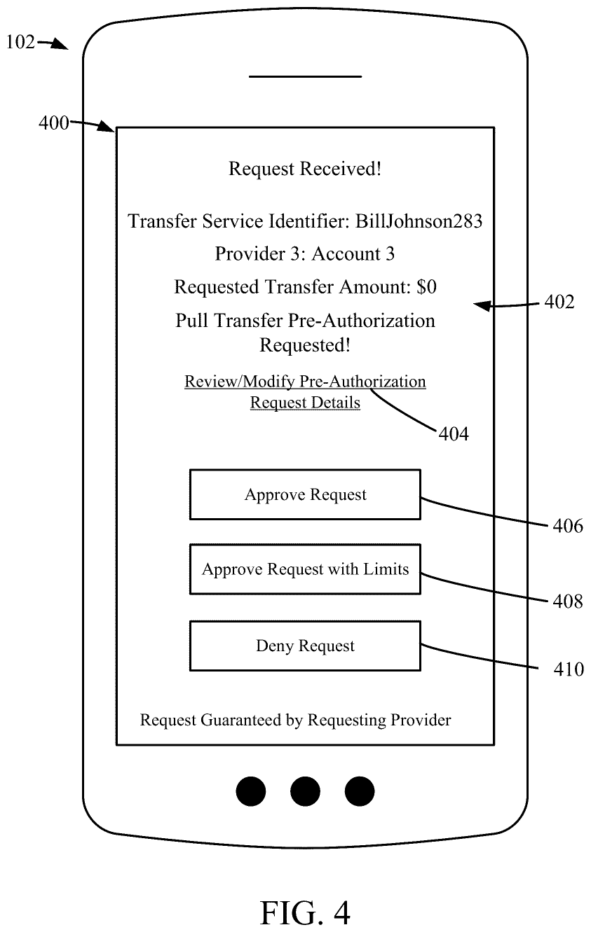

For example, referring to FIG. 4, a graphical user interface 400 providing such an alert is shown, according to an example embodiment. As shown, the graphical user interface 400 includes an information field 402 that indicates that the request has been received and provides a variety of request information to the user associated with the sending account. For example, in some instances, as illustrated, the request information includes an indication of the transfer service identifier (e.g., “BillJohnson283”) and the account information (e.g., the account number, the routing number, an indication of the provider institution at which the account is held) associated with the receiving account from which the request was sent. In some instances, the request information further includes a requested transfer amount and an indication that the requesting entity has requested pull transfer pre-authorization, as discussed above.

The graphical user interface 400 further includes a link 404 configured to allow the user to review and/or modify various pre-authorization request details. For example, the user may be able to review each of the terms and conditions set by the requesting user (e.g., the user associated with the receiving account), as discussed above. For example, in some instances, the recipient of the request (e.g., the user associated with the sending account) is able to review and/or modify the limits and timeframes set for any future pre-authorized pull transfers. The user may then select to either approve the request using a request approval button 406 or to deny the request using a request denial button 410.

In some instances, in addition or alternative to the link 404, the user may be presented with a conditional approval button 408 (e.g., an “approve request with limits” button) that, when selected by the user, allows the user to select various conditions upon which they approve of the request for pre-authorization. For example, the user may similarly be allowed to place various limitations on the pre-authorization, such as, for example, only providing the pre-authorization for a limited period of time (e.g., for a day, for a week, for a month, etc.). Accordingly, if the user clicks on the conditional approval button 408, the user will presented with various potential limitations to set, such as time frame dollar limits (e.g., daily, weekly, monthly, etc.).

In these instances, the modified or limited approval may be send back to the requester for their approval. In some instances, the requester may then be allowed to request various additional modifications. That is, the requester can make requests to modify pre-authorization request limits and/or conditions proposed by the sending account owner that will need to be approved by sending account owner. Accordingly, the requester and the user providing pre-authorization can go back and forth until the conditions of the pre-authorization are agreed upon. In any case, these limits and/or conditions will be connected to the binding by storing and cross correlating the limits and/or conditions within the account database 140, such that the requesting party only has pre-authorization to conduct real-time or near real-time pull transfers within the confines of the agreed upon limits and/or conditions.

In some instances, upon receiving the graphical user interface 400 the user may simply decide to ignore the request. In these instances, the received request may ultimately time out or otherwise expire, in which case the requesting user (e.g., associated with the receiving account) would have to send another request.

As illustrated in FIG. 4, in some instances, the requesting provider (e.g., the receiving provider associated with the receiving provider may have the option to guarantee pre-authorization requests (e.g., a guarantee option). For example, in some instances, as part of opting into the transfer service or after opting into the transfer service, providers (e.g., the receiving provider associated with the receiving provider computing system 104 and/or the sending provider associated with the sending provider computing system 106) communicate with the transfer service computing system 108 to enable or otherwise select an option to offer a pre-authorization guarantee. The term “pre-authorization guarantee” is used herein to refer to the provider (e.g., the receiving provider) promising to pay back to the sender associated with the sending account any funds (or in sometimes any funds up to a guaranteed amount selected by the provider) that are fraudulently pulled via a pre-authorized transfer using an account held at or otherwise maintained by the provider (e.g., if the account has been hacked or otherwise taken over). In some instances, the guarantee option is not a user customer decision but a provider or bank decision. That is, in these instances, the requesting bank is guaranteeing that the requester is not fraudulent and the requesting bank is underwriting the funds if a claim determines that a given request was fraudulent.

In some instances, by enabling or otherwise offering the pre-authorization guarantee, the customers of the corresponding provider (e.g., the receiving provider) may be allowed to perform higher limit pulls than customers of other providers, which may be particularly useful when transferring funds to a new account. Further, by offering the pre-authorization guarantee, providers allow for the recipients of the pre-authorization requests to approve the pre-authorization requests without taking on the risk associated with the requestor potentially being fraudulent. That is, the guarantee option, if exercised by the requesting provider, will take the risk away from the sending account (e.g., the recipients of the pre-authorization requests), so if the requester was unauthorized (e.g., like account takeover) on the requester side, the guaranteed amount will be returned to the sender or sending account.

In some instances, due to the increased risk assumed by providers offering the pre-authorization guarantees, the providers offering the pre-authorization guarantees may implement or otherwise require various additional security measures (e.g., additional or heightened security steps, additional authentications processes, required collateralization from the requesting party, restricted fund usage for a period of time after pulls, etc.) to ensure that the requesting entity is the customer associated with the receiving account for pre-authorized transfers when applying the guarantee to requests. In some instances, the customer is allowed to selectively opt into these additional security measures to have their pre-authorization request guaranteed (e.g., via the link 308 shown in FIG. 3). In some other instances, the provider may automatically implement the additional security measures for all pre-authorization requests, and the provider may automatically guarantee all pre-authorization requests.

With reference again to FIG. 2, in some instances, upon receiving the pre-authorization request, the user logged into the sending account then approves the pre-authorization request (e.g., by selecting the request approval button 406), at step 208, and, in response to the user approving the pre-authorization request, the transfer service computing system 108 then binds the receiving account and the sending account within the account database 140, at step 210.

As used herein, the term “bind” is meant to indicate that the transfer service computing system 108 creates a new association between the receiving account and the sending account indicating that the sending account has given pre-authorization to the receiving account to pull funds or other resources from the sending account without any additional authorization, subject to the terms and conditions agreed upon by the user associated with the sending account. In some instances, the transfer service computing system 108 stores an indication of this association or binding within the account database 140 within the receiving account and/or the sending account. For example, the transfer service computing system 108 may create and store a cross-correlation between the sending account and the receiving account within the account database 140 (e.g., within a multi-dimensional lookup table storing account information for user accounts, identifying information associated with corresponding users of the user accounts, and/or transfer identifiers associated with each user account) that provides the receiving account with pre-authorization to initiate pull transfers from the sending account without requesting additional authorization with a holder of the sending account. Further, in some instances, the transfer service computing system 108 is configured to send a binding indication to each of the receiving provider computing system 104 and the sending provider computing system 106 to verify that each of the user has pre-authorized pull transfers from the sending account to the receiving account via the transfer service.

In some instances, prior to binding the receiving account to the sending account, the transfer service computing system may verify that both accounts are eligible to set up pre-authorized pull transfers. For example, in some instances, the transfer service entity may have various limitations (e.g., stored within a database similar to the account database 140) on the types of accounts that can perform pre-authorized pull transfers and/or the types of accounts that can be bound together to enable the pre-authorized pull transfers. For example, in some instances, the transfer service entity may only allow pre-authorized pull transfers between accounts held by the same user (e.g., me-to-me transfers). In some instances, the transfer service entity may additionally or alternatively only allow pre-authorized pull transfers between accounts meeting one or more predetermined tenure requirements. For example, the transfer service entity may only allow pre-authorized pull transfers between accounts that have been opened for at least a year and/or that have maintained a balance above a certain threshold (e.g., $100) for a predetermined amount of time (e.g., six months). Accordingly, in some instances, prior to binding the receiving account and the sending account, the transfer service computing system 108 (e.g., the transfer processing circuit 138) is configured to ensure that both accounts meet the various requirements for pre-authorized pull transfers set by the transfer service entity.

Additionally, in some instances, the transfer service entity may place their own framework, such as rules (e.g., stored within a database similar to the account database 140), on the types of pre-authorized pull transfers offered based on the types of accounts conducting the transfers. For example, in some instances, the transfer service entity may choose to provide higher limits (e.g., no limits) and/or allow higher numbers of transfers (e.g., unlimited) to pre-authorized pull transfers between accounts held by the same user (e.g., me-to-me transfers) due to the higher level of security (e.g., the lower risk of fraud) provided by verifying that each account is associated with or otherwise linked to the same universal identifier of the user. Accordingly, in some instances, the transfer service computing system 108 (e.g., the transfer processing circuit 138) may additionally only allow requested pre-authorized pull transfers meeting the rules set by the transfer service entity (e.g., entered into a user interface by a user of the transfer service computing system 108).

Accordingly, once the receiving account and the sending account have been bound within the account database 140, the user associated with the receiving account has been successfully pre-authorized to pull funds or other resources from the sending account without the need for additional authorization (assuming that the requested pull transfer is within the bounds of the agreed upon terms and conditions).

In some instances, after the user associated with the receiving account has been pre-authorized and the receiving account has been bound with the sending account, the transfer service computing system 108 receives a pull transfer request from the receiving account requesting to pull funds or other resources from the sending account, at step 212.

For example, in some instances, the user associated with the receiving account may log into the banking application associated with the receiving provider (e.g., the receiving provider client application 116) via the user device 102 and be provided with a user interface similar to the graphical user interface 300 shown in FIG. 3. For example, in some instances, the user interface may further include an indication of the pre-authorized or bound accounts (e.g., the sending account) from which user can pull funds or other resources into the receiving account via a pre-authorized pull transfer. Accordingly, the user is able to initiate the pull transfer in a similar manner to that described above.

However, in the case of the user selecting a pre-authorized or bound account from which to request money, the request is automatically completed by the transfer service computing system 108, at step 214, without the transfer service computing system 108 requesting any additional authorization from the user associated with the sending account. That is, the transfer service computing system 108 enables funds or other resources to be pulled from the sending account and transferred to the receiving account based on the stored binding between the receiving account and the sending account.

In some instances, the transfer service computing system 108 may automatically initiate the pull transfer request based on the terms and conditions agreed upon by the user associated with the sending account. For example, if the user associated with the receiving account is a service provider or other entity that is charging the user associated with the sending account, the terms and conditions may include, for example, one or more scheduled payments proposed by the service provider or other entity and agreed to by the user associated with the sending account. Accordingly, the transfer service computing system 108 may automatically initiate various pull transfer requests at the agreed upon intervals and amounts based on the agreed to terms and conditions.

Accordingly, the systems and methods described herein allow for pre-authorized real-time or near real-time pull transfers from a sending account held by a sending provider to be initiated by a user associated with a receiving account held by a receiving provider without requiring additional authorization due to the prior stored pre-authorization.

However, in some instances, even though pre-authorized, a given real-time or near real-time pull transfer may fail for a variety of reasons. For example, if the sending account has an insufficient balance, a hold has been placed on the sending account, the sending account has been closed, or the sending account has recently failed a risk screen, a requested pre-authorized pull transfer may fail.

In some instances, in the case of a failed request, the transfer service computing system 108 is configured to automatically generate and transmit an alert or other notification to the user device 102 associated with the user requesting the pre-authorized pull transfer. For example, if the failed request was in response to a request initiated by a user via the user device 102 (e.g., as discussed above with respect to FIG. 3), the alert or other notification may be provided as a subsequent screen to the user submitting the transfer request. If the failed request was in response to a scheduled payment pull attempt, the alert or other notification could be provided to the user device 102 as a pop-up window or push notification. The alert or notification sent to the user device 102 may include a prompt requesting that the user select one of three potential options. For example, the user may be provided with user interface (e.g., similar to the graphical user interface 400) including a first selectable button, a second selectable button, and a third selectable button (e.g., similar to the request approval button 406, the conditional approval button 408, and the request denial button 410) configured to allow the user to select between the three options.

In some instances, the first button is configured to allow the user to select to switch the pre-authorized pull transfer to an automated clearinghouse transfer over traditional bank payment rails. In some instances, the second button is configured to allow the user to select for the transfer service computing system 108 to retry the pre-authorized pull transfer again at a later date or a pre-determined number of times (e.g., every day for the next week). In some instances, the third button is configured to allow the user to abandon the requested pre-authorized pull transfer.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by a computing system, a pre-authorization request from a first client application associated with a first account held at a first provider institution, the pre-authorization request requesting that the first account be bound to a second account held at a second provider institution, wherein binding the first account to the second account pre-authorizes a first user of the first account to perform real-time or near real-time pull transfers of resources from the second account into the first account using a transfer service;
transmitting, by the computing system, the pre-authorization request to a second client application associated with the second account;
receiving, by the computing system, an approval of the pre-authorization request from the second client application associated with the second account; and
binding, by the computing system, the first account with the second account based on the approval of the pre-authorization request.

2. The method of claim 1, wherein binding the first account to the second account comprises:
creating, by the computing system, an association between the first account and the second account indicating that the first account is pre-authorized to perform the real-time or near real-time pull transfers of resources from the second account into the first account; and
storing, by the computing system, the association within an account database.

3. The method of claim 1, further comprising:
receiving, by the computing system, a request to perform a real-time or near real-time pull transfer of resources from the second account into the first account from the first client application; and
initiating, by the computing system, the real-time or near real-time pull transfer from the second account into the first account without requesting additional authorization from a second user of the second account based on the first account being bound to the second account.

4. The method of claim 1, wherein the first account and the second account are both held by the first user.

5. The method of claim 1, further comprising:
receiving, by the computing system, a registration request to register the first account with the transfer service, the registration request including a user characteristic of the first user of the first account;
determining, by the computing system, that the user characteristic matches an existing universal transfer identifier registered with the transfer service;
identifying, by the computing system, the second account as being associated with the existing universal transfer identifier; and
in response to identifying the second account as being associated with the existing universal transfer identifier, providing, by the computing system, an indication of the second account to the first client application.

6. The method of claim 5, wherein the indication of the second account is provided to the first client application via a graphical user interface including a selectable option to request pre-authorization for pull transfers from the second account into the first account, and the pre-authorization request is received in response to the first user selecting the selectable option via the graphical user interface.

7. The method of claim 1, wherein the first account is held by a provider of goods and/or services, the second account is held by a customer purchasing the goods and/or services from the provider, and the pre-authorization request is associated with a recurring payment.

8. The method of claim 1, wherein the pre-authorization request includes one or more limitations comprising at least one of an approved transfer limit, an approved transfer amount, or an approval time period within which pull transfers are allowed.

9. The method of claim 1, wherein the approval of the pre-authorization request includes one or more modifications comprising at least one of a modified approved transfer limit, a modified approved transfer amount, or a modified approval time period within which pull transfers are allowed.

10. The method of claim 1, wherein the pre-authorization request is received without a corresponding resource transfer request for a transfer of resources from the second account into the first account.

11. The method of claim 1, wherein the pre-authorization request is transmitted to the second client application via a graphical user interface including a pre-authorization guarantee indication indicating that the first provider institution is guaranteeing a predetermined amount of pre-authorized pull transfers from the second account into the first account, and wherein the first provider institution guarantees the predetermined amount of pre-authorized pull transfers without input from the first user regarding guaranteeing the predetermined amount.

12. One or more non-transitory computer-readable media having instructions thereon that, when executed by at least one processing circuit of a computing system, cause the at least one processing circuit to perform operations comprising:
receiving a registration request to register a first account held at a first provider institution with a transfer service from a first client application associated with the first account, the registration request including a user characteristic of a user associated with the first account;
determining that the user characteristic matches an existing universal transfer identifier registered with the transfer service;
identifying a second account held at a second provider institution as being associated with the existing universal transfer identifier;
in response to identifying the second account as being associated with the existing universal transfer identifier, providing an indication of the second account to the first client application; and
binding the first account to the second account based on a pre-authorization request from the first client application being approved by a second client application associated with the second account, wherein binding the first account to the second account pre-authorizes a first user of the first account to perform real-time or near real-time pull transfers of resources from the second account into the first account using the transfer service.

13. The one or more non-transitory computer-readable media of claim 12, wherein the indication of the second account is provided to the first client application via a graphical user interface that further includes a selectable option to request pre-authorization for pull transfers from the second account into the first account, and the pre-authorization request is received from the first client application in response to the user selecting the selectable option via the graphical user interface.

14. The one or more non-transitory computer-readable media of claim 12, wherein the operations further comprise:
receiving a request to perform a real-time or near real-time pull transfer of resources from the second account into the first account from the first client application; and
initiating the real-time or near real-time pull transfer from the second account into the first account without requesting additional authorization from a second user of the second account based on the first account being bound to the second account.

15. The one or more non-transitory computer-readable media of claim 12, wherein the first account and the second account are both held by the user.

16. A provider computing system associated with a first provider institution, the provider computing system comprising:
one or more processing circuits including one or more processors and one or more memories, the one or more memories having instructions stored thereon that, when executed by the one or more processors, cause the one or more processing circuits to:
receive a pre-authorization request from a first client application associated with a first account held by a user at the first provider institution, the pre-authorization request requesting that the first account be bound to a second account held by the user at a second provider institution, wherein binding the first account to the second account pre-authorizes the user to perform real-time or near real-time pull transfers of resources from the second account into the first account using a transfer service;
transmit the pre-authorization request to a second client application associated with the second account; and
receive an approval of the pre-authorization request from the second client application associated with the second account; and
receive a notification that the first account has been bound with the second account based on the approval of the pre-authorization request.

17. The provider computing system of claim 16, wherein the instructions further cause the one or more processing circuits to:
receive a request to perform a real-time or near real-time pull transfer of resources from the second account into the first account from the first client application; and
initiate the real-time or near real-time pull transfer from the second account into the first account, wherein the real-time or near real-time pull transfer is performed without requesting additional authorization from the user via the second client application based on the first account being bound to the second account.

18. The provider computing system of claim 16, wherein the instructions further cause the one or more processing circuits to:
receive a registration request to register the first account with the transfer service, the registration request including a user characteristic of the user;
transmit the registration request to a transfer service computing system associated with the transfer service;
receiving an indication of the second account from the transfer service computing system based on the user characteristic matching an existing universal transfer identifier registered with the transfer service and cross-correlated with the second account.

19. The provider computing system of claim 18, wherein the indication of the second account is provided to the first client application via a graphical user interface including a selectable option to request pre-authorization for pull transfers from the second account into the first account, and the pre-authorization request is received in response to the user selecting the selectable option via the graphical user interface.

20. The provider computing system of claim 16, wherein the instructions further cause the one or more processing circuits to:
receive an indication of conditional approval of the pre-authorization request from the second client application, the indication of conditional approval including one or more modifications comprising at least one of a modified approved transfer limit, a modified approved transfer amount, or a modified approval time period within which pull transfers are allowed; and
receive a modification approval of the one or more modifications from the first client application.
